(19) United States
(12) Patent Application Publication
(10) Pub. No.: US 2013/0088824 A1
(43) Pub. Date: Apr. 11, 2013

(54) PORTABLE COMPUTER WITH HIGHLY ADJUSTABLE ERGONOMIC DISPLAY SCREEN

(71) Applicant: Anto A. John, Trichy (IN)

(72) Inventor: Anto A. John, Trichy (IN)

(73) Assignee: INTERNATIONAL BUSINESS MACHINES CORPORATION, Armonk, NY (US)

(21) Appl. No.: 13/267,454

(22) Filed: Oct. 6, 2011

(51) Int. Cl. G06F 1/16

(52) U.S. Cl. 361/679.06

(57) ABSTRACT

A portable computer system with a highly adjustable display is disclosed. In one embodiment, a laptop computer includes a base and a display supported from a base by a pair of opposing support arms. Each support arm includes a pair of rigid structural members coupled at adjacent ends by an intermediate connector comprising one or two ball joints. The lower rigid structural member is connected to the base by a lower ball joint, and the upper rigid structural member is connected to the display by a display connector comprising an upper ball joint. The display connector is also secured to a side edge of the display on a track. The laptop has an adjustable viewing angle, fore/aft position, and display height.

### BACKGROUND

1. Field of the Invention

The present invention relates to portable computer systems, and more particularly to a portable computer system having an adjustable display.

2. Background of the Related Art

The advent of the personal computer (PC) in the latter half of the twentieth century led to the widespread use of electronic devices to digitally store and process information. The technologies used in computers and other electronic devices have continued to advance, aided by economies of scale, and with ongoing reinvestment in product research and development. Factors such as increasing miniaturization and related improvements in memory density and processor speed, along with vastly improved electronic displays and user input peripherals, have led to the development of many different electronic consumer products. Modern electronic devices are now capable of storing large amounts of information in digital form, even on very compact, lightweight, and portable devices. Popular portable electronic devices with built-in or otherwise connected display screens currently include laptop computers, tablet computers, smartphones, digital music players, and handheld electronic game consoles.

Laptop computers are particularly desirable due to their combination of portability and computing capabilities. A laptop, while portable, is still large enough to include a selection of hardware that is more robust and powerful than other portable computing devices. For example, compared to a similarly priced tablet computer, a laptop will typically have a faster processor, better graphics processor, and greater amount of memory, along with more numerous peripheral ports and the inclusion of an optical drive. Almost all mainstream computer tasks and applications may be performed on laptop computers. Also, current laptops have increasingly larger amounts of hard drive storage, on par with the size of hard drives in “desktop” computers of the very recent past. As a consequence, laptops have largely supplanted the desktop in the computer market.

In computing, good user ergonomics is important to user productivity. Consumer demand for portability has led to laptop computers achieving very compact form factors, with dimensions just large enough to accommodate a display and a keyboard of usable size. However, the goal of making a laptop compact can be at odds with the goal of providing good ergonomics. While laptops do incorporate many ergonomic features, such as full-sized keyboards with good tactile response, the design objectives of portability and ergonomics are sometimes at odds.

### BRIEF SUMMARY

A portable computer system is disclosed having a highly adjustable display, wherein any combination of a height of the display, a fore/aft position of the display, a side-to-side position of the display, and a viewing angle of the display may be obtained. The portable computer system includes a base and a display, where the base includes a keyboard and the display is supported on the base by a pair of adjustable support arms. The pair of adjustable support arms support the display at opposing side edges of the display, allowing movement of the display between a plurality of positions with respect to the base. Each support arm includes first and second rigid structural members, such as a first rod and a second rod. The first rod is coupled at one end to the base with a base connector including a ball joint. The second rod is coupled to a display connector including a ball joint. The display connector is movable along the respective side edge of the display on a track. An intermediate connector comprising at least one ball joint couples an opposing end of the first rod to an opposing end of the second rod.

### BRIEF DESCRIPTION OF THE SEVERAL VIEWS OF THE DRAWINGS

FIG. 1 is a perspective view of one embodiment of a portable computer system (laptop) with a highly adjustable display.

FIG. 2 is a perspective view of the laptop wherein the height of the display has been increased by raising the display as guided by the track

FIG. 3 is a perspective view of the laptop with the display further raised to its maximum height.

FIG. 4 is a perspective view of the laptop with the fore/aft position of the display moved forward.

FIG. 5 is a perspective view of the laptop with the fore/aft position of the display moved rearward.

FIG. 6 is a perspective view of the laptop with the display moved to a closed position.

FIG. 7 is a perspective view of an alternative display connector that includes an integrated track and ball joint combination.

FIG. 8 is a schematic diagram of an example embodiment of an intermediate connector comprising two ball joints.

### DETAILED DESCRIPTION

A portable computer system with a highly adjustable display is disclosed. The portable computer system is specifically a laptop computer (i.e. “laptop”), which has a base and a display. The base includes a keyboard and contains the motherboard and other hardware components. The display is supported from the base by a pair of opposing support arms. The support arms each have similar construction, though disposed on opposing sides of the base and display. Each support arm includes first and second rigid structural members, such as a pair of rods, joined at adjacent ends by an intermediate connector comprising one or two middle ball joints. A lower rod is connected to the base by a lower ball joint. An upper rod is also connected to the display by a display connector comprising an upper ball joint. The display connector is also secured to a side edge of the display on a track, which provides some height adjustment to the display. The upper, middle, and lower ball joints, in combination with the track, allow the display to be positioned in any of a broad range of different positions. While the disclosed laptop can mimic the open position of a conventional, hinged laptop, the disclosed laptop also has an adjustable viewing angle, fore/aft position, and display height, for improved ergonomics and usability. For example, the display may be positioned at an angle, height and distance that is appropriate for the users height and vision.

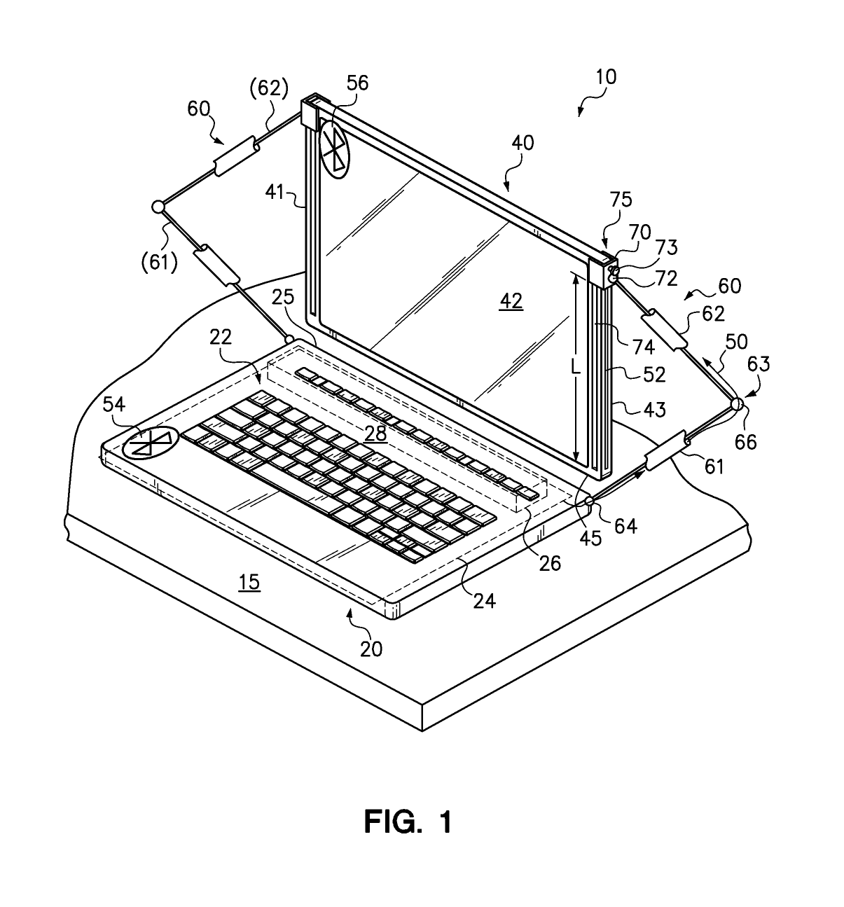

FIG. 1 is a perspective view of one embodiment of a portable computer system (i.e. “laptop”) 10 with a highly adjustable display 40. The laptop 10 includes a base 20 configured for resting on a work surface 15, such as of a desk or table, with the display 40 supported from the base 20 by a pair of adjustable support arms 60. The base 20 includes a keyboard 22, which may comprise a conventional “QWERTY” keyboard layout, a motherboard 24, and a battery 26 for supplying power to the laptop 10. The QWERTY keyboard is preferably a physical keyboard with independently moveable keys, which provides a better ergonomic advantage than a virtual keyboard displayed on a glass surface. An A/C adapter (not shown) may be used for alternatively powering the laptop 10 from a wired electrical outlet and for charging the battery 26. The display 40 is a flat, panel-style display 40 that is thin and lightweight for portability and positionability. The display 40 may incorporate any of a variety of conventional electronic display technologies. For example, the display 40 may include a liquid crystal display (LCD) having a backlight and an array of liquid crystals to modulate the backlight. Graphical content is electronically displayed on a viewing surface 42 on a front face of the display 40. The adjustable support arms 60 support the display 40 from the base 20 at opposing side edges 41, 43 of the display 40. The support arms 60 allow the height, fore/aft position, and viewing angle of the display 40 to be adjusted. The laptop 10 is shown with some example structure in FIG. 1, and in a primarily schematic representation in the remaining figures, to facilitate discussion of these positional adjustments.

The right-side support arm 60 is further detailed in FIG. 1. Except where noted, any details of the right-side support arm described and shown in the figures may be included in both support arms 60. Each support arm 60 includes a rigid first rod 61, a rigid second rod 62, and an intermediate connector 63 comprising at least one ball joint 66 that couples the first rod 61 with the second rod 62. The at least one ball joint 66 allows the rods 61, 62 to pivot over a broad range of angles with respect to one another about the ball joint 66. The first rod 61 is coupled at an end to the base 20 with a base connector that includes a ball joint 64. The second rod 62 is coupled at one end to the respective (right) side edge 43 of the display 40 using a display connector 70. The display connector 70 includes a ball joint 72 at the end of the second rod 62 opposite the first ball joint 66, about which the second rod 62 may pivot. The display connector 70 is movable along the right side edge 43 of the display 40 on a track 75. The three ball joints may be referred to, for convenience, as the upper ball joint 72, the middle ball joint 66, and the lower ball joint 64.

Electrical wiring, indicated by arrows at 50, connects the base 20 to the display 40, and is routed through the right-side support arm 60 as indicated by the arrows. The wiring 50 carries electrical power and electrical signals from the base 20 to the display 40. The electrical power may be supplied directly or indirectly from the battery 26 in the base 40, or the optional A/C adapter. The electrical signals, which may include digital images to be displayed, are generated by electronic components within the base 20, such as by a graphics card or an integrated graphics processor on the motherboard 24. The electrical wiring 50 in FIG. 1 is internally routed through the support arm 60, from the base 20, through the (base connector) lower ball joint 64, the first rod 61, the middle ball joint 66, the second rod 72, the upper ball joint 72 and the display connector 70, and to the display 40. The display 40 includes an elongate slot 52 along the right edge 43 of the display 40, through which the electrical wiring 50 is routed into the display 40. The optional internal routing of the electrical wiring 50 provides a clean appearance and protects the electrical wiring from external damage. However, in a suitable alternative routing, the electrical wiring 50 may simply be routed externally, directly from the base 20 to the display 40.

The laptop 10 may also include a wireless transmission system for optionally communicating between the base 20 and the display 40. The wireless transmission system may optionally be used as a substitute for carrying display signals through electrical wiring 50. The wireless system includes a wireless transmitter 54 in the base 20 and a wireless receiver 56 in the display 40. The wireless transmitter 54 and receiver 56 may both be transceivers for two-way communication between the base 20 and the display 40. The display signals generated at the motherboard 24 may be broadcast wirelessly over the wireless transmitter 54 and received by the wireless receiver 56, whereupon the display signals may get decoded and displayed on the display 40. In this particular example, the wireless transmitter 54 and receiver 56 operate according to a Bluetooth (tm) protocol. Bluetooth is a proprietary open wireless technology standard for exchanging data over short distances, using short wavelength electromagnetic transmissions in the ISM band from 2400-2480 MHz. Bluetooth is a registered trademark of Bluetooth SIG, Inc.

A track for allowing the display 40 to be raised or lowered may be structurally implemented in any of a variety of ways. By way of example, the track 75 in the embodiment of FIG. 1 includes a groove 74 along the right side edge 43 of the display 40, and an inwardly facing protrusion (not shown) on the display connector 70 rides in the groove 74. The track 75 may also include an outer surface of the display 40 along the right side edge 43, to which the inner surface of the display connector closely conforms. As the display 40 is alternately raised and lowered, the protrusion rides in the groove, and the display connector 70 moves along the right side edge 43 of the display 40. The display connector 70 is secured to the display 40, in this case, by the protrusion riding within the groove 74. Linear movement between the display 40 and the display connector 70 along the track 75 is limited by the slot length “L.” In FIG. 1, the display 40 is at a lowest position with respect to the display connector 70, i.e., the display connector 70 is at the highest position of its travel along the track 75. Sufficient friction may be provided between the display 40 and the display connector 70 to support the weight of the display 40 with the display connector 70 at any selected height. Alternatively, a track locking mechanism 73, such as a spring-loaded pin or threaded pin rotatable by hand, may be provided for selectively locking and unlocking the display connector 70 at any selected height. In a locking mode, for example, the pin may engage a physical feature of the display such as by frictionally engaging a surface or being inserted into a recess. In an unlocking mode, the pin may disengage from the physical feature of the display 40.

The support arms 60 allow the display 40 to be positioned at any desired height, fore/aft position, side-to-side position, and viewing angle. The support arms even allow the display to be reversed to face in the opposite direction (i.e., away from the keyboard or base). The height of the display 40 may be defined with respect to a vertical distance between a lower edge 45 of the display 40 and an upper surface 28 of the base 20 that contains the keyboard 22. The fore/aft position of the display 40 may be defined with respect to a horizontal distance between the lower edge 45 of the display and a rear edge 25 of the base 20, such as in a direction parallel to the work surface 15 or upper surface 28 of the base 20. The viewing angle may be defined as the angle between the viewing surface 42 of the display 40 and the upper surface 28 of the base 20 (or the work surface 15). This adjustability allows the user to position the display 40 at a position that the user finds comfortable or provides the best ergonomic advantage, depending on the particular user, the situation in which the laptop 10 will be used, and the environment in which the laptop 10 is to be used.

In FIG. 1, the display 40 is in a first, open position comparable to a conventional open laptop position. The height of the display 40 is at its lowest position (nearly zero), wherein the lower edge 45 of the display 40 is nearly touching the base 20. The fore/aft position is neutral (zero), wherein the lower edge 45 of the display 40 is approximately vertically aligned with the rear edge 25 of the base 20. The viewing angle is approximately ninety degrees. The viewing angle may be adjusted by pivoting the display 40 about its lower edge 45, as accommodated by the adjustable support arms 60. In one embodiment, the viewing angle is adjustable over a range of at least about 45 degrees to 135 degrees. This position of the display 20 is very similar to the relative positioning of a conventional laptop display having a hinged connection between a display and a base. However, unlike a conventional laptop, the height and fore/aft position of the display 40, in addition to the viewing angle, are also adjustable.

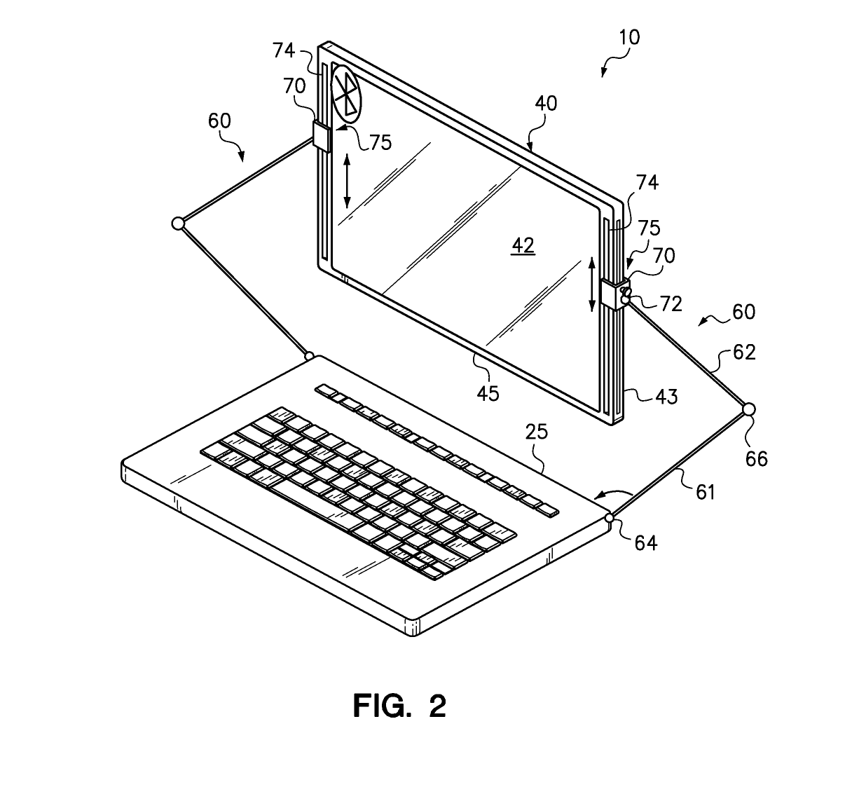

FIG. 2 is a perspective view of the laptop 10 wherein the height of the display 40 has been increased by raising the display 40 as guided by the track 75 (schematically indicated by a dashed line). The height has been increased without changing the viewing angle or appreciably changing the position of the support arms 60. The display 40 is now approximately halfway along the range of travel provided by the track 75, which positions the display connectors 70 approximately midway up the side edge 43. The track 75 will accommodate further upward movement of the display 40 with no change in position of the support arms 60. When in the raised position of the display 40 relative to the display connectors 74, friction and/or a locking mechanism may be used to hold the display 40 in the raised position. From this position, the viewing angle could be changed by pivoting the display 40 about the upper ball joints 72, by pivoting the upper rods 62 relative to the lower rods 61 about the middle ball joints 66, and/or by pivoting the lower rod 62 about the lower ball joints 64. Each of these adjustments may also affect the fore/aft position of the display 40.

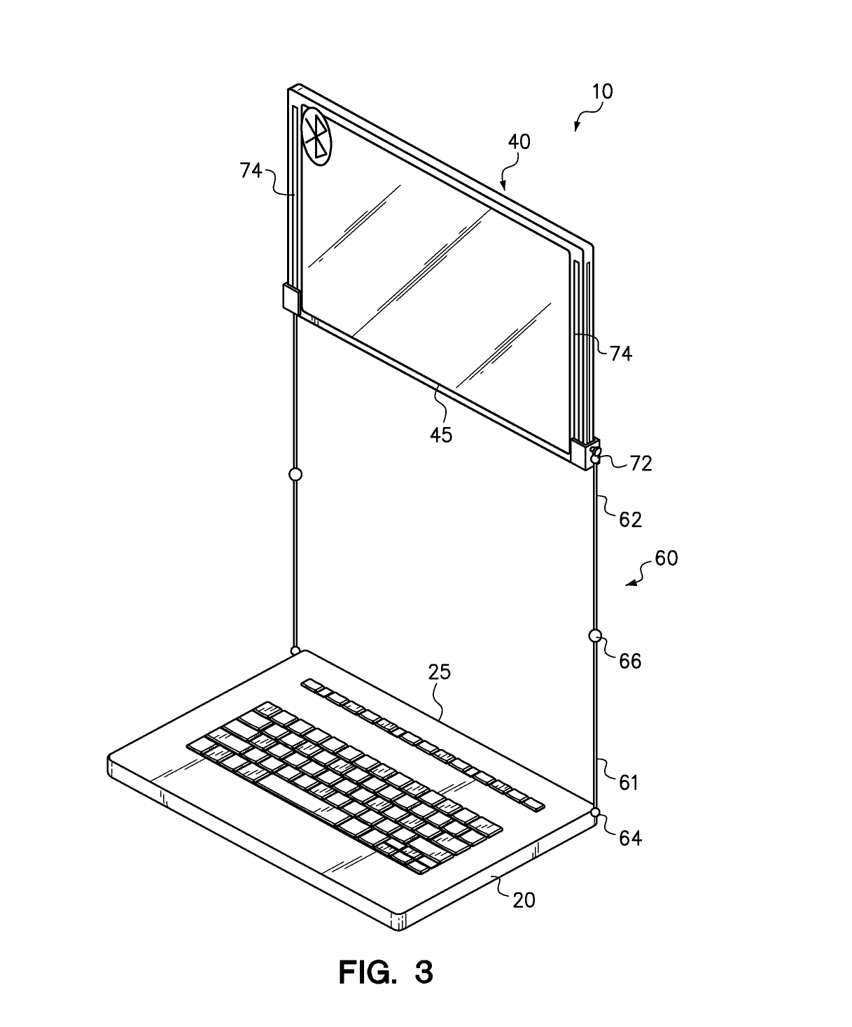

FIG. 3 is a perspective view of the laptop 10 with the display 40 further raised to its maximum height, while optionally maintaining the same viewing angle as in FIGS. 1 and 2. This maximum height of the display 40 is achieved by further raising the display 40 to one end of its travel along the track 75, in combination with straightening the pivot arms 60 about the intermediate connector 63. The length of each support arm 60, when straightened, is greater than the length of the side edges 43 of the display 40 in this embodiment. This additional length of the support arms 60 allows the height of the display 40 relative to the base 20 to be adjusted by alternately changing the angle between the support arms at the middle ball joint 66, in addition to the height adjustment provided by the track 75. The display 40 may be positioned at any desired height between its lowest position of FIG. 1 and its highest position of FIG. 3. The desired height of the display 40 relative to the base 20 may be selected by a user depending, for example, on the height of the user, to position the height of the display 40 at approximately eye level for that user. Again, the viewing angle and fore/aft position may be individually adjusted while the display connectors 70 are at their lowest point of travel along the track 75. As in FIGS. 1 and 2, the angle of the display 40 relative to the base 20 in FIG. 3 is shown to be about ninety degrees, which positions the display 40 at a neutral fore/aft position. Adjustments to the viewing angle or fore/aft position may reduce the height of the display 40.

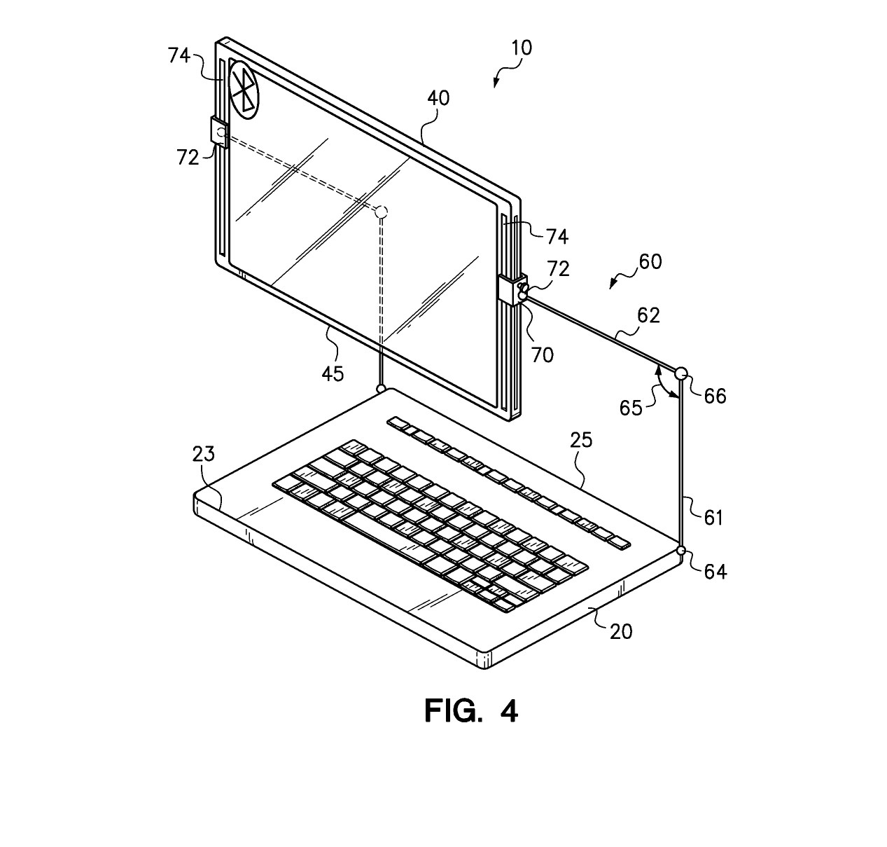

FIG. 4 is a perspective view of the laptop 10 with the fore/aft position of the display 40 moved forward (toward the user) by changing the angle between the support arms 60 about the middle pair of ball joints 66. The user may move the display 40 forward, for example, if the user has longer arms, or is myopic (nearsighted), or if a display font is particularly small. In the position of FIG. 4, the lower edge 45 of the display 40 is now positioned forward of the rear edge 25 of the base 20 (i.e. nearer to the user). The lower edge 45 may be positioned at least 5 cm forward of the rear edge 25 of the base. In one embodiment, the lower edge 45 of the display 40 may be positioned at or even in front of the front edge 23 of the base 20. Positioning the display 40 at or near the front edge 23 of the base 20 may be desirable in a photograph display mode, for example, where the keyboard is “hidden” from the user behind the display 40. This adjustment reduces an angle 65 between the upper rod 62 and lower rod 61 from 180 degrees in FIG. 3 to an obtuse angle of less than 180 degrees in FIG. 4. This change in the bend of the support arms 60 consequently reduces the height of the display 40. One useful aspect of the particularly large range of adjustability provided by the track 75 is to offset any height reduction caused by fore/aft adjustments. Thus, even though the support arms 60 are no longer pointed straight up as in FIG. 3, the track 75 still provides ample height adjustment for the display 40. The fore/aft position may be further changed by further changing the angle between the support arms 60 about the middle ball joint or by pivoting the lower rods 61 about the lower ball joints 64.

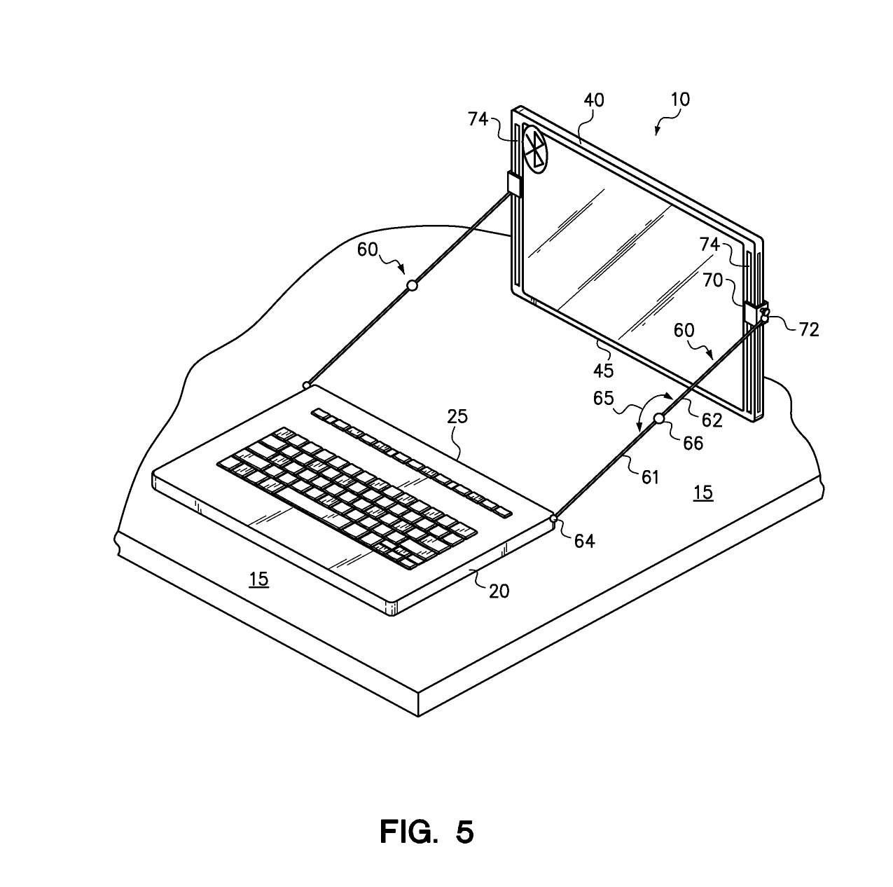

FIG. 5 is a perspective view of the laptop 10 with the fore/aft position of the display 40 moved rearward (away from the user) by straightening the support arms 60 and orienting the support arms 60 behind the base 20. With the angle 65 between the upper rod 62 and lower rod 61 approximately 180 degrees, and the support arms 60 pivoted about the lower ball joints 64 to a nearly flat or horizontal position, the display 40 is about as far back as the support arms 60 will allow. In this position of the display 40, the torque about the ball joints 64, 66, 72 caused by the weight of the display 40 may be too great for the support arms 60 to support the weight of the display 40 in this position, or the torque may be sufficient to tip over the laptop 10. Therefore, optionally, the display 40 may be rested on the work surface 15 while in this extreme rearward position.

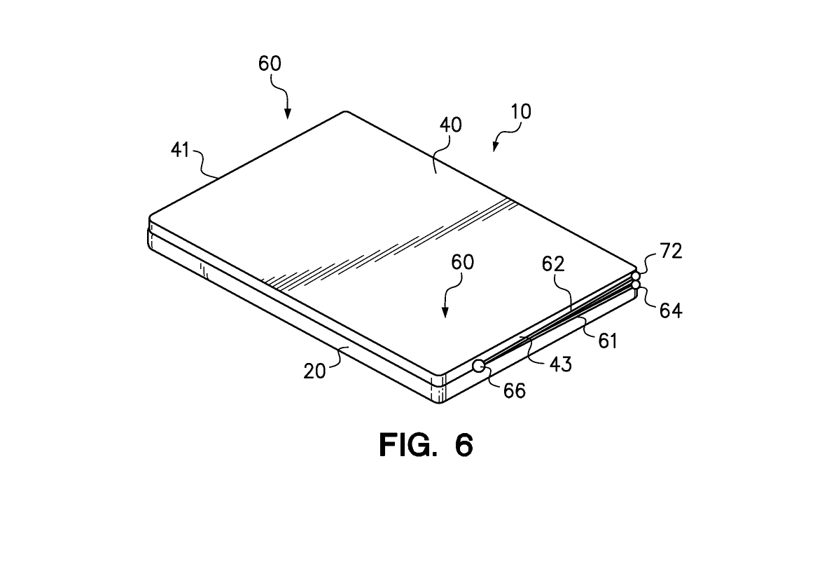

FIG. 6 is a perspective view of the laptop 10 with the display 40 moved to a closed position. The support arms 60 on opposing sides of the laptop 10 are each folded about the middle ball joint 66, with the upper rod 62 in alignment with the lower rod 61, and in alignment with the respective side edge 41, 43 of the display. In this closed position, the viewing surface 42 is facing inwardly toward the upper surface 18 of the base (now both hidden from view; see preceding figures), which protects the viewing surface 42 and the keyboard 22. However, the display be also be reversed and still moved to the closed position, such that the viewing surface faces outwardly akin to a tablet computer. With the support arms 60 folded and moved inward along the side edges 41, 43 of the display 40, the overall form factor and footprint is similar in size to a conventional laptop. With the support arms 60 remaining in this position, it is possible to open and close the display in the same as a conventional laptop having a conventional hinge between the base and the display.

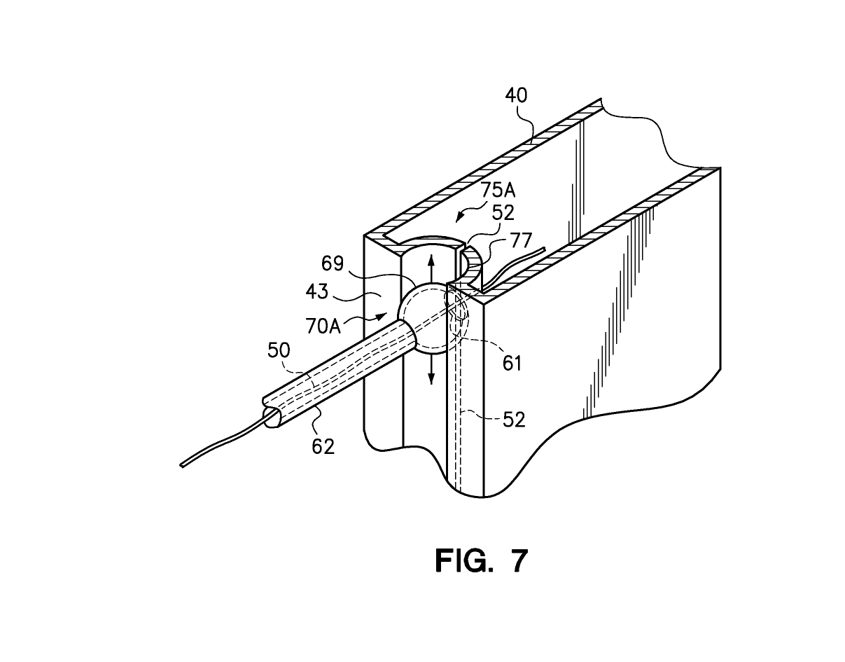

FIG. 7 is a perspective view of an alternative display connector 70A (shown in a sectioned, perspective view) that includes an integrated track 75A and ball joint 72A combination. The track 75A includes an elongate channel 77 formed along and aligned with the right side edge 43. The channel 77 has an arcuate cross-sectional shape that conforms to a ball end 69 at the end of the upper rod 62. The channel 77 extends past 180 degrees, to retain the ball end 69. Thus, the ball socket in this embodiment comprises the ball end 69 disposed within the arcuate channel 77, allowing the upper rod 62 to rotate about the ball end 69. Simultaneously, the elongate channel 77 constrains the ball end 69 to translate along the channel 77, analogously to the way in which the display connector 70 and ball socket 72 of FIG. 1 moves along the edge 43 of the display 40. The upper rod 62 may be hollow, to allow the electrical wiring 50 to be routed internally to the upper rod 62. The ball end 69 may have an aperture 61 through which the electrical wiring 50 may exit into the display 40 through the elongate slot 52.

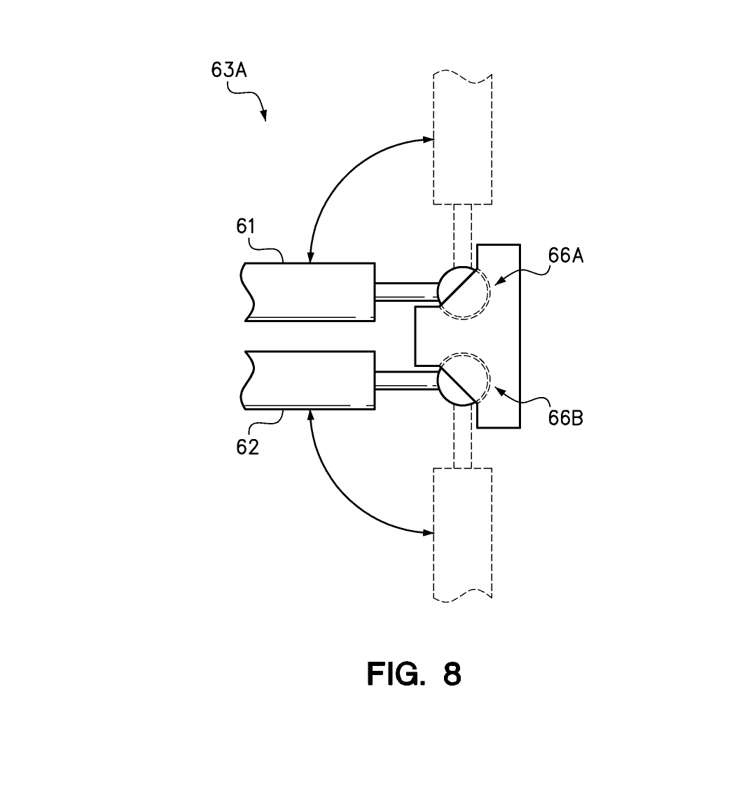

FIG. 8 is a schematic diagram of an example embodiment of an intermediate connector 63A comprising two ball joints 66A, 66B that could be substituted for the single ball joint 66 of FIG. 1. The rods 61, 62 of the support arm 60 are shown in the folded position of FIG. 6 using a solid line type, and in the straightened, 180-degree position of FIG. 5 using a phantom line type. Each ball joint 66A, 66B has approximately 90 degrees of travel within the plane of the page. When combined, the two ball joints 66A, 66B provide the 180 degrees of movement required to fold the support arms 60 as shown in the closed laptop position of FIG. 6. The ball joints 66A, 66B also each have some freedom to move in planes transverse to the plane of the page, to facilitate manipulation of the support arms 60 in the various positions shown in FIGS. 1-6.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A portable computer system, comprising:
a base including a keyboard;
a display; and
a pair of adjustable support arms for supporting the display at opposing side edges of the display, the support arms allowing movement of the display between a plurality of positions with respect to the base and for supporting the display in each position, each support arm including a first rigid structural member coupled at one end to the base with a base connector including a ball joint, a second rigid structural member coupled to a display connector including a ball joint, the display connector movable along the respective side edge of the display on a track, and an intermediate connector comprising at least one ball joint coupling an opposing end of the first rigid structural member to an opposing end of the second rigid structural member.

2. The portable computer system of claim 1, wherein the intermediate connector further comprises:
first and second ball joints, wherein the first and second rigid structural members are pivotable with respect to one another about both of the first and second ball joints.

3. The portable computer system of claim 1, wherein each support arm has a length that is greater than a length of the side edge of the display.

4. The portable computer system of claim 1, wherein the plurality of positions comprise:
a closed position wherein a front face of the display containing a viewing surface is against an upper surface of the base containing the keyboard; and
a first open position wherein the viewing surface of the display is angled away from the upper surface of the base between 45 and 135 degrees about a lower edge of the display, and wherein the display is movable along the track to alternately raise or lower the display with respect to the base while in the first open position.

5. The portable computer system of claim 4, further comprising:
in the closed position, the first and second rigid structural members of each support arm are folded about the intermediate connector in alignment with each other and with the respective side edge of the display.

6. The portable computer system of claim 5, wherein the display is movable to any angle between 45 and 135 degrees about the lower edge of the display while in the first open position.

7. The portable computer system of claim 4, wherein the plurality of positions comprise:
a second open position wherein the viewing surface of the display is angled away from the upper surface of the base between 45 and 135 degrees about a lower edge of the display, and wherein the support arms extend behind the base to position the display behind the first position.

8. The portable computer system of claim 1, further comprising:
electrical wiring routed through at least one of the support arms from the base to the display.

9. The portable computer system of claim 8, wherein the electrical wiring is routed from the base, through the base connector, the first rigid structural member, the intermediate connector, the second rigid structural member, and the display connector to the display.

10. The portable computer system of claim 8, further comprising:
an elongate slot along the side edge of the display adjacent to the support arm, wherein the electrical wiring is routed from the support arm through the elongate slot and into the display.

11. The portable computer system of claim 1, further comprising:
a track locking mechanism changeable between an unlocking mode wherein the display is movable along the track to a selected position and a locking mode wherein the display is secured in the selected position.

12. The portable computer system of claim 1, wherein the display is supported exclusively by the display connectors on the support arms.

13. The portable computer system of claim 1, wherein the plurality of positions comprise:
an open position wherein the viewing surface of the display is angled away from the upper surface of the base between 45 and 135 degrees about a lower edge of the display, and wherein the support arms are angled toward a front edge of the base that positions the display forward of a rear edge of the base.

14. The portable computer system of claim 13, wherein the display is at least 5 cm forward of the rear edge of the base in the open position.

15. The portable computer system of claim 1, further comprising:
a wireless transmitter on the base configured for wirelessly transmitting graphical output to be displayed on the display; and
a wireless receiver on the display configured for wirelessly receiving the graphical output transmitted from the base on the display.

16. The portable computer system of claim 15, wherein the wireless transmitter and wireless receiver operate using a Bluetooth protocol.

17. The portable computer system of claim 1, wherein the first and second rigid structural members are rods.
